(19) United States
(12) Patent Application Publication
(10) Pub. No.: US 2011/0283954 A1
(43) Pub. Date: Nov. 24, 2011

(54) Pet play toy

(76) Inventor: Terrance P. Zachary, Surrey (CA)

(21) Appl. No.: 13/068,562

(22) Filed: May 13, 2011

Related U.S. Application Data
(60) Provisional application No. 61/395,502, filed on May 14, 2010.

(51) Int. Cl. A01K 29/00

(52) U.S. Cl. 119/707

(57) ABSTRACT

The current innovation refers to a pet toy that is generally shaped like a traditional ‘boomerang’, having a main, generally central elbow and two arms, and yet also mimics the shape, texture and appearance of a common ‘stick’ or ‘branch’ found in nature, and may attract a pet and/or pet owner as in the case of a common fetch game or chew toy.

This application claims priority to the provisional application 61/395,502 filed on May 14, 2010.

### BACKGROUND OF THE INVENTION

The present invention is in the field of pet toys. More specifically it is designed to be a fetch toy and chew toy.

There exist many items that may be used as fetch toys, some which are natural such as a stick or branch, and some which are man-made. The current device combines the generally bent base shape of a man-made boomerang and the appearance of a natural stick, the result being an item that is attractive to pets as a tug/chew toy as well as being exciting and unpredictable in reaction when thrown as a fetch toy.

### SUMMARY OF THE INVENTION

The current device mimics the natural stick as well as the man-made boomerang which creates an attractive and inventive fetch toy that reacts unpredictably and a tug/chew toy that is attractive in its uniqueness.

The shape of the current device is like that of a traditional boomerang, being devised of a main, generally central elbow and two defined arms that create an elbow, the preferred angle of the elbow being approximately 140 degrees.

The elbow may form a point or may be rounded, each embodiment lending to a different action, bounce or kick that occurs when the device contacts the ground once thrown. The preferred embodiment for the current device elbow is rounded, which allows for more consistent action per throw from the user.

The arms themselves may be generally straight, mildly crooked, mildly twisted or subtly convex relative to the ‘outside,’ ‘backside,’ or ‘opposite of the angle’ side of the device, or any combination thereof. Subtly convex is the preferred embodiment referring to the outside of the arms. The convex shape of the outside arms lends to greater and more consistent action, bounce or kick upon contact with the ground once thrown. Each arm may stray subtly from the true straight in order to improve unpredictability of the bounce when thrown and also to mimic the naturally crooked appearance of a stick. The subtle stray would not detract from the boomerang-based nature of the device.

The shape of the current innovation causes the device to react categorically and uniquely depending on how it is thrown by the user and indeed how it makes contact with the ground surface. The result is a play toy and fetch game where the pet is intrigued by the excitability and unpredictability of the bounce resulting from the throws of the user and the reaction of the unique shape of the device when it contacts the ground.

The cross-sectional shape of the device simulates a natural stick or branch originating from nature, being generally round in cross-section. Its outer surface can appear rough mimicking the bark of a common branch stick, or it can appear smooth mimicking that of the bark of the branch or stick having been peeled or stripped or having fallen off. In either case, the defining appearance of the outer surface of the device is ‘branch-like’ or ‘stick-like.’

The center of gravity (or balance point) of the current device should be located at the elbow of the device such that the pet can carry the toy in its mouth without effort, discomfort or imbalance. The center-weighted nature of the device makes it enjoyable and pleasant to carry. The center-weighted nature of the device also makes it easy to hang in packaging or in display in a petstore.

From the general boomerang shaped stick, the current device may house several unique features, the first being a ‘knot,’ as is common in a stick, branch or piece of wood. The knot may act as a mere aesthetic touch in attracting the pet so to be representative of a stick or branch in appearance, or it may be larger and serve the function to create more ‘action’ in the bounce or ‘kick’ upon landing once the device is thrown. There may be single or multiple knots on the device and the knots may be located at any position. The knot or knots may protrude outward or inward. A knot that protrudes outward may have a sharply defined, rough, rounded or unlevel edge so as to affect the action, bounce or kick of the device when it is thrown and contacts the ground.

The second unique feature of the device is one or several ‘off-plane knobs’, or branches or ‘curves’ coming off of or away from the main plane of the boomerang shape of the device. Its purpose is to provide the potential for a more interesting and unpredictable kick or contact reaction when the device is thrown by the user and contacts the ground. The knob serves to kick the device off-plane when the device contacts the ground at the point of the off-plane knob lending to greater unpredictability and excitement. There may exist one or several off-plane knobs in the device. The preferred embodiment includes one off-plane knob. The off-plane knob may deviate from the main arm plane in any direction or angle lending to various iterations of the device and thus many unique actions, bounces and/or kick patterns. The off-plane knob may be straight, curved, crooked, twisted, rough or smooth or any combination of the above. It's end may be sharp (as in ‘cut by a saw’), rough, rounded or unlevel or any combination of, lending to various unique actions, bounces and kick patterns upon being thrown and contacting the ground on the said off-plane knob.

The off-plane knob also acts to assist the pet in grabbing it during a fetch when the device has settled, as well as when attempting to chew it, as it permits the device to prop up off of the ground plane somewhat and be easily accessible when at rest.

The device may have sharply-cut, angled (unlevel), rounded or rough appearing ends. The preferred embodiment for the current device is rounded and the specific finished appearance of the end is ‘ringed’ representing the rings of a tree. The rounded end allows the device to react with more action, bounce and kick and the ringed appearance is for aesthetics alone, depicting a tree origin and may be attractive to both owner and pet.

The basic design of the device may include a ribbed area that can welcome and accommodate the user's hands and/or fingers and thumb such that the gripping of the device is comfortable and stable to the user, whether left handed or right handed.

The basic design of the current device may include an area that can welcome a separate throwing device attachment such that the user does not have to grab the stick directly by hand and can also use the throwing device and throwing device attachment to gain leverage during their throw of the current device. The basic design of the device may also include an area for acceptance into a holster.

The basic design of the stick may include an area to hide pet treats. This hidden pet treat area would not in itself define the inventive nature of the current inventive device.

Functionally, due to the unique design of the device that appears as a stick in the shape of a boomerang, the device reacts categorically depending upon how it is thrown (overhand, side-arm, underhand), as well as how it happens to contact with the ground once thrown. The boomerang shape has a tendency to compress, launch and forward rotate or ‘run’ and/or ‘hop’ as a common landing and reaction pattern. It also has a ‘stalled’ landing and ‘back-up kick’ pattern when it rotates and lands such that it contacts the ground with an end of the stick. When the preferred embodiment includes an off-plane knob, there exists an unpredictable ‘lateral-kick’ or ‘off-plane-kick’ landing pattern. All landing actions attract and excite the pet. All landing actions are also useful in that they attract other pet owners when they witness the current device's unique actions and reactions, and this may stimulate a future purchase, as in referral or advertisement.

The generally boomerang base appearance creates a unique rotation when thrown by a pet owner, made even more unique by the presence of an off-plane knob. This rotation pattern is unique to the current invention in that it is active and excitable to pets when thrown, and also attracts other pet owners who are witness to it because of its unique action; and thus who may also be drawn towards a future purchase as in referral or advertisement.

Regardless of the preferred embodiment, the pet is drawn by the unpredictability, visual satisfaction and excitability of the current pet toy's response to contacting with the ground once thrown. The reaction and attraction of the device is the result of the utility of the current design.

The current device can be thrown using the two preferred throw start positions, the first being vertical with the ‘angle side’ of the device facing the intended line of the throw, and the second being vertical with back or ‘opposite of the angle’ side facing the intended line of the throw. Regardless of set up by the thrower, the current device launches in an end over end clockwise rotating flight in the direction of the intended line. The two preferred throw start positions result in all reaction patterns upon landing, those being tumble forward and run, tumble forward and hop, off-plane-kick-left and off-plane-kick-right, stall, and back-up; and all combinations thereof.

The current device can be made in an assortment of different colors or may be transparent, fluorescent, or may even glow, yet the preferred embodiment would be that representing the color of a true tree branch or stick in nature. Thus, light brown, dark brown, white or any other color or combination of colors that depict a tree branch are all acceptable as long as the color and pattern represent a type of branch from a type of tree. That said, the current invention can be made to be any color, mix of colors or any pattern of colors that are deemed effective in marketing the product or in branding or in attracting and keeping the attention of a pet. Regardless of final color presentation, the color of the current device does not define the invention, and only defines its branding attempt, marketability or ability to attract and keep the attention of a pet or pet owner.

The outer texture of the preferred embodiment of the current device mimics that of a branch that naturally occurs in nature whether that branch is represented as being covered in bark or as having the bark stripped off and thus as being smooth. That said, the current invention can have any texture that is deemed to aid in marketing or branding the invention or in attracting or maintaining the attention of pets or pet owners.

The smell and taste of the current boomerang shaped stick does not define the current invention. It may smell and taste of rubber, polyurethane, or of whatever its base material consists, or it may smell and taste as that of the smell and/or taste that has been deemed attractive to pets in gaining and maintaining their attention or the attention of the pet owner (in the case of smell).

The material used in the preferred embodiment may be any form of approved rubber, plastic, polyurethane, thermoplastic or other elastomer, any chemical or oil related end product, wood or any other natural or man-made material or of a material that permits both land and water use, and thus floats. The material used in manufacturing of current invention is deemed to aid in the marketing, branding or manufacturing of the invention or in attracting or maintaining the attention of a pet or pet owner. The material of the product may also include an approved ingredient or ingredients that are opaque to x-ray examination, thus making the material locatable in case of diagnostic necessity in cases such as from swallowing. The material selected for manufacturing does not define the invention and is only debated in consideration of manufacturing relevance, costing, safety and marketing issues.

The size of the current invention can be very tiny as in the example of a promotional item representing the current invention, such as a keychain, to extremely large as in consideration of a pet toy for a huge pet.

In regards to the functional preferred embodiment, the size of the current invention would have a length between 5 inches and 30 inches. The preferred embodiment for smaller pets or younger pets would be 10 inches in length from one endpoint to another. The preferred embodiment for medium-sized pets would be 14 inches in length. The preferred embodiment for larger pets or adult pets would be 18 inches in length from one endpoint to another.

The diameter of the preferred embodiment of the current device for small pet would be 1 inch, the diameter of the preferred embodiment for a medium-size pet would be 2 inches, and the diameter of the preferred embodiment for a large pet would be 3 inches.

The current device could be built and marketed as: smaller for smaller pets, larger for larger pets, considering baby to full-grown pets and taking into account breed size and strength and jaw size and strength.

The weight of the current inventive device would range from 2 ounces to 2 pounds. The weight of the preferred embodiment for a smaller device offered to a smaller pet would be 10 ounces, the weight of the preferred embodiment for a medium pet would be 1 pound, and the weight of the preferred embodiment for a large pet would be 1.5 pounds.

The shore durometer of the preferred design of the current device for land use is 80 D. A land and water device would have a lower durometer.

The elbow angle between the main arms is desired to be between 60 and 170 degrees, the preferred embodiment being approximately 140 degrees.

The following drawings are supplied to further describe the specifications of the current inventive device:

### DRAWINGS

FIG. 1 is a perspective lateral view of the current device;

FIG. 2 is a simplified lateral view of the pet toy device of FIG. 1;

FIG. 3 is a perspective direct anterior to posterior view down the main plane of the current pet toy device;

FIG. 4 is a simple knobless frontal view of the current device;

FIG. 5 is a simple frontal view of the current pet toy; and

FIG. 6 is a perspective view of the current device showing convex arms, preferred grip ribs, end rings and center of gravity.

### DETAILED DESCRIPTION OF THE INVENTION

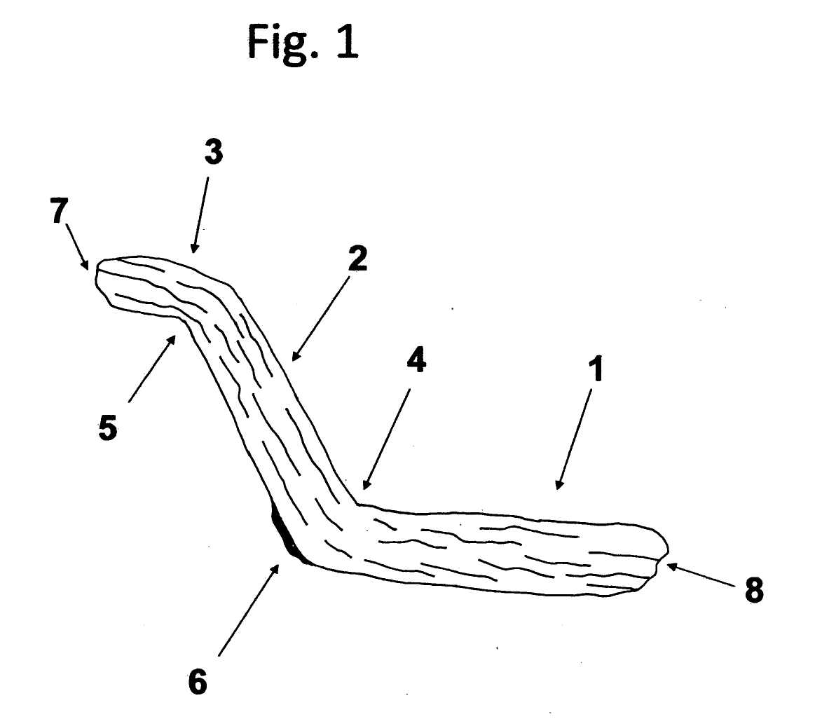

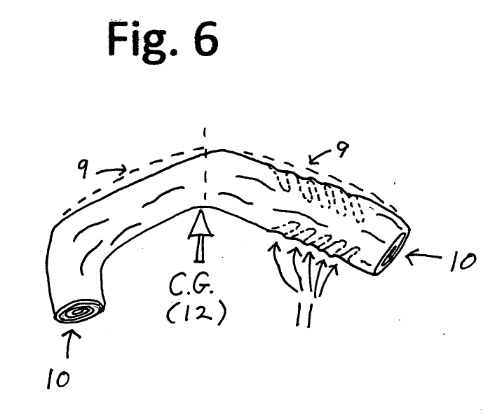

Referring now to the invention in detail, in FIG. 1 there is shown a pet toy depicting a basic boomerang shape defined by two arms 1 and 2 having a generally central elbow represented by angle 4. The shape defined by arms 1 and 2 having the angle 4 has the appearance of a stick found in nature when viewed in cross section (as opposed to the flat cross-section appearance of true boomerang), depicted best in FIG. 6. The device that presents as a stick that is in the general shape of a boomerang serves to allow the device to react dramatically and unpredictably when thrown and allowed to contact with the ground, thus keeping the attention of pets, pet owners, other pets and other pet owners.

The ends of the arms 7 and 8 shown in FIG. 1 can be rough as in representing a broken stick in nature, can be sharp as in a sawed stick (or piece of wood), can be angled or unlevel to elicit unpredictable bounce reactions, or can be somewhat rounded to influence ease and consistency of ‘bounce’ and ‘run’ action. There can be a ‘ringed’ end appearance 10 as depicted in FIG. 6 which acts to be aesthetically pleasing to pets and pet owners.

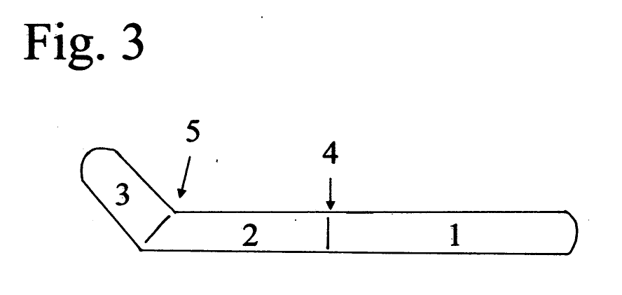

The preferred embodiment includes an off-plane knob 3 in FIG. 1 and is especially shown to be off of the plane of arms 1 and 2 in FIG. 3. The off-plane knob acts to kick the device laterally or off plane when thrown and landed on, and also acts to prop the device off the ground for easier pick-up by the owner or the pet. The off-plane knob 3 may also be desirable as a point for chewing by a pet. The off-plane knob 3 may waver off of the base plane defined by arms 1 and 2 in any direction so as to give the manufacturer many options to produce various ‘action’ responses (and thus the potential for multiple brands) once different iterations are produced. The off-plane knob may be generally straight, twisted, crooked or curved based upon appearance as a natural part of a stick or branch from a main stick, as well as for emphasizing its role in adding unusual reactions once thrown and contacted with the ground. There may exist one or multiple knobs as part of the current device. The preferred embodiment includes one off-plane knob.

The various directions of the off-plane knob 3 allows for many iterations of the current device resulting in many bounce patterns. The off-plane knob 3 generally mimics a bend or a separate branch coming off of a stick in nature and is shorter than either arm 1 and 2 so to emphasize the generally dominant base boomerang shape of the device. The off-plane knob end may be rough, cut, unlevel or rounded in shape as previously shown as 7 and 8 in FIG. 1. The preferred end of the off-plane knob is rounded so as to influence consistent and proficient action, bounce or kick once thrown and contacted onto with the ground.

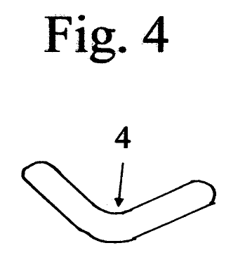

The device may also not include an off-plane knob as illustrated in FIG. 4 to emphasis the utility of true bounce and run in mainly one plane as a result of the basic boomerang shape of the stick-appearing device.

The back (side of the arms away from the angle 4) of the arms are well defined in all illustrations yet FIG. 6 best depicts where the options for the back side of the arms are generally straight or convex 9 (see dotted line). The convex back of the arms is the preferred embodiment and permits better and more consistent action of bounce and run when the device is tossed by the owner and contacts the ground thereafter.

The device may include a ribbed 11 area that welcomes the fingers of a thrower or carrier as is depicted in FIG. 6. This also aids the owner in a tug game with a pet.

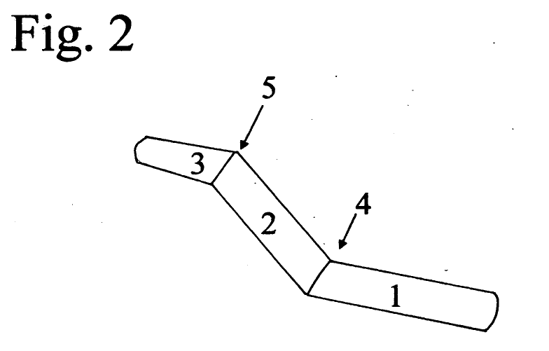

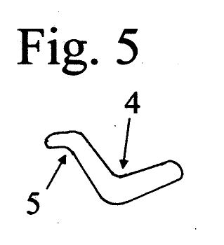

The preferred embodiment of the device places the center of gravity CG #12 in FIG. 6 near the center angle 4 on FIG. 1-5, allowing the pet to easily carry the item without effort, discomfort or fatigue, so as not to be turned off or frustrated by any awkwardness of handling of the device.

I claim:

1. A pet play toy that is unique in that its structure combines the core shape of a boomerang, that of having a generally central elbow and two arms, with the shape, texture and appearance of a stick found in nature, as described herein.

2. A pet play toy as described in claim 1 that has novel arms that are crooked instead of straight like a true boomerang that functionally will improve the unpredictability of the bounce when thrown and contacting with the ground and also more mimics the natural appearance of a stick so as to attract a pet.

3. A pet play toy as described in claim 1 that has novel arms that are twisted as opposed to straight like a true boomerang that functionally will improve the unpredictability of the bounce when thrown and contacting with the ground and also more mimics the natural appearance of a stick so as to attract a pet.

4. A pet play toy as described in claim 1 that has novel arms that are convex in structure relative to the opposite of the angle side of the arms instead of straight like a true boomerang that functionally will improve the degree of forward bounce and roll when thrown and contacting with the ground.

5. A pet play toy as described in claim 1 that has one or more novel off-plane knobs that are shorter than the two defining arms of the toy and serves to kick the toy off plane when thrown and contacting with the ground and also serves to prop the toy off of the ground upon it settling so as to be more easily grasped by the pet or pet owner and also serves to be conveniently chewed by the pet.”
